(19) United States
(12) Patent Application Publication
(10) Pub. No.: US 2013/0085867 A1
(43) Pub. Date: Apr. 4, 2013

(54) Niche Keyword Recommendation

(71) Applicants: Bin Gao, Beijing (CN); Tie-Yan Liu, Beijing (CN)

(72) Inventors: Bin Gao, Beijing (CN); Tie-Yan Liu, Beijing (CN)

(73) Assignee: MICROSOFT CORPORATION, Redmond, WA (US)

(21) Appl. No.: 13/249,939

(22) Filed: Sep. 30, 2011

(51) Int. Cl. G06Q 30/02; G06Q 30/08

(52) U.S. Cl. 705/14.71

(57) ABSTRACT

A computing device is described herein that is configured to select a subset of keywords from a plurality of keywords based at least on measures of competition associated with the keywords and to suggest the selected subset for bidding. The plurality of keywords is relevant to at least one advertising target. The computing device calculates a measure of competition for a respective keyword based on a number of bidders for the respective keyword and on a number of available advertisement slots in search results provided responsive to queries for the respective keyword.

### BACKGROUND

Businesses continually seek ways to improve their revenues through advertising. By sharing the benefits of their products or services through advertisements, these businesses add valued customers. Historically, advertising efforts have not been targeted. Instead, advertisements have been placed on billboards, in magazines, or on television channels that are viewed by many different types of people. With the advent of the Internet and other services interacting with users and logging user behavior, however, the opportunities for targeted advertising have greatly increased.

One example of targeted advertising that has become increasingly important to businesses is sponsored searching. In sponsored searching, advertisers bid on various keywords. The winning bidder or bidders have their advertisements placed in advertisement slots on search result pages returned to users that searched for the bid-upon keyword. By allowing advertisements to be associated with specific words known to be of interest to users, businesses achieve a high degree of advertisement targeting and ensure that advertisements reach the potential consumers that they are most likely to interest.

There are a number of problems with sponsored searching, however. Quite often, advertisers bid on a very small number of highly popular keywords. The result of this focus on a small number of keywords is high prices in keyword auctions. Additionally, a large number of other keywords are not bid upon or are only bid upon infrequently. As a result, advertisement slots on search result pages for these other keywords are often wasted.

### SUMMARY

This application describes techniques for selecting a subset of keywords relevant to an advertising target based at least on measures of competition calculated for the keywords. Computing devices configured to implement these techniques calculate a measure of competition for a respective keyword based on a number of bidders for the respective keyword and on a number of available advertisement slots in search results provided responsive to queries for the respective keyword. The computing devices then suggest the selected subset of keywords for bidding to an advertiser associated with the advertising target.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

The detailed description is set forth with reference to the accompanying figures, in which the left-most digit of a reference number identifies the figure in which the reference number first appears. The use of the same reference numbers in different figures indicates similar or identical items or features.

FIG. 1 illustrates an example environment for selecting a keyword subset based on measures of competition, in accordance with various embodiments.

FIG. 2 is a block diagram of an example computing device system architecture of a computing device configured to select a keyword subset based on measures of competition, in accordance with various embodiments.

FIG. 3 is a flowchart showing an illustrative process for selecting a keyword subset based on measures of competition, in accordance with various embodiments.

### DETAILED DESCRIPTION

Described herein are techniques for selecting a subset of keywords from a plurality of keywords based at least on measures of competition associated with the keywords and suggesting the selected subset for bidding. The plurality of keywords is relevant to at least one advertising target. An advertising target comprises at least one of one or more advertisement copies or one or more previously bid keywords, the advertisement copies and previously bid keywords associated with an advertisement group of an advertiser. A computing device configured to implement the techniques calculates a measure of competition for a respective keyword based on a number of bidders for the respective keyword and on a number of available advertisement slots in search results provided responsive to queries for the respective keyword. In some embodiments, the computing device may also suggest a bidding price for one or more keywords of the subset of keywords.

In some embodiments, the computing device selects the plurality of keywords from a keyword superset based on relevancies of the keywords in the keyword superset to the advertising target.

In addition to measures of competition, the computing device may utilize one or more other keyword measures in selecting the subset of keywords. These measures may include keyword prices, query frequencies associated with the keywords, relevancy scores of the keywords, cross-similarities of the keywords with respect to each other, or a budget constraint. The keyword price for each keyword may be a lowest price for the keyword over a time period. The relevancy score of each keyword is calculated as an average of similarities of the keyword to a set of words associated with the advertising target. The query frequency associated with each keyword is a frequency with which the keyword is queried during a time period. The budget constraint is used as an upper bound to a sum of products of the keyword prices of the selected keywords with click-through rates of the selected keywords and query frequencies of the selected keywords.

In some embodiments, the computing device selects the subset of keywords based on a result of a combinatorial optimization algorithm that includes terms representing one or more of the above keyword measures. The combinatorial optimization algorithm minimizes the term representing the measures of competition and maximizes the terms representing the keyword prices, the query frequencies, the relevancy scores, and the cross-similarities of the selected keywords with respect to each other. Also, in some embodiments, one or more of the terms of the combinatorial optimization algorithm may be associated with weighting factors.

### Example Environment

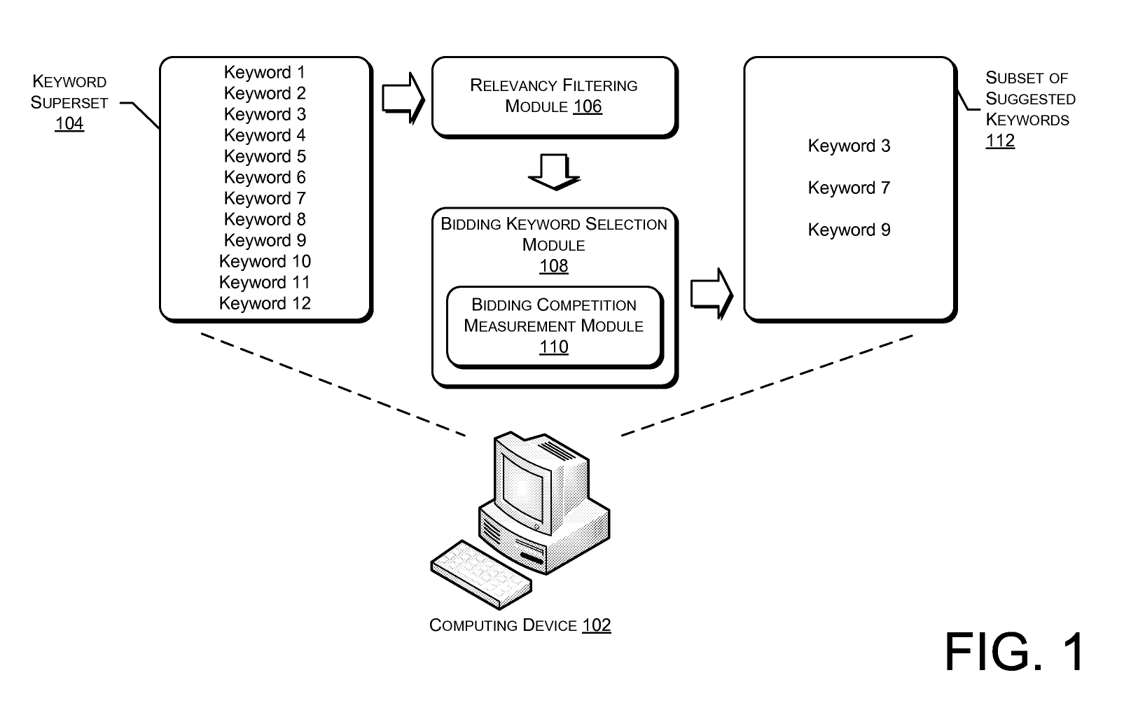

FIG. 1 illustrates an example environment for selecting a keyword subset based on measures of competition, in accordance with various embodiments. As shown in FIG. 1, a computing device 102 determines relevancies of keywords of a keyword superset 104 to an advertising target. A relevancy filtering module 106 of the computing device 102 then filters the keywords of the keyword superset 104 and selects a plurality of keywords from the keyword superset 104 based on the determined relevancies. After selection of the plurality of keywords, a bidding keyword selection module 108 of computing device 102 determines one or more measurements for the plurality of keywords, including at least measurements of competition determined by a bidding competition measurement module 110 of the bidding keyword selection module 108. Based on the determined measurements, the bidding keyword selection module 108 then selects a subset of suggested keywords 112 to suggest to an advertiser associated with the advertising target.

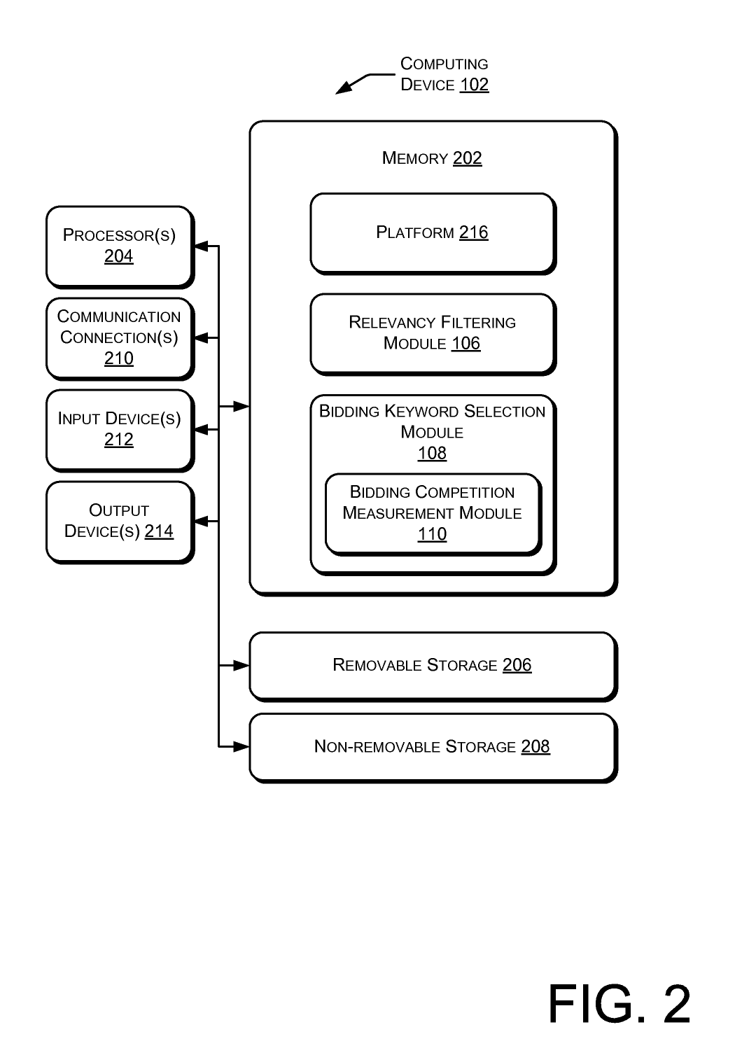

In various embodiments, the computing device 102 may be any sort of computing device or computing devices. For example, the computing device 102 may be or include a personal computer (PC), a laptop computer, a server or server farm, a mainframe, a tablet computer, a work station, a telecommunication device, a personal digital assistant (PDA), a media player, a media center device, a personal video recorder (PVR), a television, or any other sort of device or devices. In one implementation, the computing device 102 represents a plurality of computing devices working in communication, such as a cloud computing network of nodes. When implemented on multiple computing devices, the computing device 102 may distribute the modules 106-110 among the multiple devices. In some implementations, the computing device 102 represents one or more virtual machines implemented on one or more computing devices. The nature and functions of the modules 106-110 are described further herein. An example computing device 102 is illustrated in FIG. 2 and is described below in greater detail with reference to that figure.

In some implementations, a network or networks may connect multiple devices represented by the computing device 102, as mentioned above. Also, such a network or networks may connect the computing device 102 to other devices, such as devices providing advertising targets or keyword supersets 104. The network or networks may be any one or more networks, such as wide area networks (WANs), local area networks (LANs), or the Internet. Also, the network or networks may be public, private, or include both public and private networks. Further, the network or networks may be wired, wireless, or include both wired and wireless networks. The network or networks may utilize any one or more protocols for communication, such as the Internet Protocol (IP), packet based protocols, or other protocols. Additionally, the network or networks may comprise any number of intermediary devices, such as routers, base stations, access points, firewalls, and/or gateway devices.

As illustrated in FIG. 1 and mentioned above, the computing device 102 takes a keyword superset 104 as input. The keyword superset 104 is a universal set of keywords, such as all bidding keywords used in previous searches or keyword auctions or all words from a dictionary. Keywords used in previous searches or keyword auctions may be retrieved from search logs, auction logs, or advertiser databases, which may be stored locally on the computing device 102 or on one or more remote computing devices. The retrieved keyword superset 104 may also be stored locally or remotely and updated on a predetermined or event driven basis. Further, the retrieved keyword superset 104 may be denoted as W={w₁, w₂, . . . , wₛ}, where w₁, w₂, . . . , wₛ are the keywords comprising the keyword superset 104 and s is the number of keywords comprising the keyword superset 104.

In addition to the keyword superset 104, the computing device 102 takes one or more advertising targets as input. An advertising target comprises one or more advertisement copies and/or one or more previously bid keywords. The advertisement copies and previously bid keywords are associated with an advertisement group of an advertiser. The advertisement group may comprise part of an advertising campaign for a product or service. In one embodiment, advertisement copies are represented as a bag of words and the advertising target is the union of the bag of words and the previously bid keywords. Such an advertising target may be denoted as V={v₁, v₂, . . . , vₜ}, where v₁, v₂, . . . , vₜ are the words in the union of the bag of words and the previously bid keywords and t is the number of words in the union of the bag of words and the previously bid keywords.

In various embodiments, the relevancy filtering module 106 of the computing device 102 takes the advertising target and keyword superset 104 as inputs and determines relevancies of the words of the advertising target to the keywords of the keyword superset 104. The relevancy filtering module 106 determines the relevancies by calculating a relevance score rᵢ for each keyword wᵢ in the keyword superset 104. The relevance score rᵢ is an average of similarity measures between wᵢ and the words of V. Each similarity measure may be denoted as sᵢⱼ and the algorithm for calculating rᵢ may be defined as:

$${r}_{i} = \frac{1}{t} {\sum }_{j = 1}^{t} {s}_{ij}$$

These similarity measures sᵢⱼ may be computed using the random walk method on a query-URL bipartite graph. Such a graph may be extracted from a search log. In some embodiments, the computing device 102 or another device may have already determined similarity measures for each keyword within the keyword superset 104 with respect to each other keyword in the keyword superset 104.

Once the relevancy filtering module 106 has calculated the relevancy scores, the relevancy filtering module 106 selects a subset of the keywords from the keyword superset 104 based on the relevancy scores. For example, the relevancy filtering module 106 may select m keywords from the keyword superset 104 with the top relevancy scores or may select all keywords from the keyword superset 104 with relevancy scores over a threshold z. These selected keywords form an intermediate set of keywords that are evaluated by the bidding keyword selection module 108. The intermediate set of keywords is referred to in some parts herein as the “plurality of keywords.”

In various embodiments, after determining the intermediate set of keywords, the computing device 102 invokes its bidding keyword selection module 108, and the bidding keyword selection module 108 in turn invokes its bidding competition measurement module 110 to determine a measure of competition for each keyword in the intermediate set of keywords. The bidding competition measurement module 110 calculates a measure of competition for a respective keyword based on a number of bidders for the respective keyword and on a number of available advertisement slots in search results provided responsive to queries for the respective keyword. Information such as the number of bidders for a keyword and the number of advertisement slots may be retrieved from search logs, auction logs, or advertiser databases. For example, there might historically have been 10 bidders for a keyword and 5 advertisement slots in search results provided responsive to queries for that keyword. In another example, the number of advertisement slots equals or exceeds the number of bidders. In such an example, the measure of competition is set to zero. In some embodiments the algorithm used by the bidding competition measurement module 110 in calculating the measures of competition may be defined as:

$$c = \frac{1}{1 + {e}^{τ ( l - y )}} - \frac{1}{1 + {e}^{τ l}}$$

where c is the measure of competition for a respective keyword, y is the number of bidders that bid on the respective keyword, l is the number of the available advertisement slots in the search results provided responsive to the queries for the respective keyword, and τ is a weighting factor. In one embodiment, τ is a number greater than 0, such as 0.3, 0.5, etc. The number τ may be determined heuristically or based on experience.

The bidding competition measurement module 110 returns these measures of competition to the bidding keyword selection module 108, and the bidding keyword selection module 108 may select the subset of suggested keywords 112 based on the measures of competition. For example, the bidding keyword selection module 108 may select a specified number of keywords from the intermediate set of keywords with the lowest competition scores or may select all keywords from the intermediate set of keywords with relevancy scores over a threshold number. Because all the words in the intermediate set of keywords have already been determined to be relevant, this selected subset of suggested keywords 112 represents relevant keywords having the least competition.

In further embodiments, the bidding keyword selection module 108 also determines keyword prices for each keyword in the intermediate set of keywords, utilizes the keyword prices in selecting the subset of suggested keywords 112, and provides the keyword price of each keyword of the subset of suggested keywords 112 with that keyword. The bidding keyword selection module 108 determines the keyword price of a respective keyword by looking at a number of keyword auctions over a time period and selecting the lowest winning bid price during that time period. Winning bid prices may be retrieved from search logs, auction logs, or advertiser databases. If no bids were made during the time period, the floor bid price from the auctions is selected as the keyword price. These keyword prices may be denoted as pᵢ. After determining the prices and receiving the measures of competition, the bidding keyword selection module 108 may select keywords based on both the measures of competition and the keyword prices, giving some weight to each. The weights may be tuned to maximize advertiser profits. Also, the bidding keyword selection module 108 may utilize a budget constraint to ensure that the selected subset of suggested keywords 112 does not exceed the advertiser's budget.

In additional embodiments, as mentioned above, the bidding keyword selection module 108 also calculates and uses other keyword measurements in selecting the subset of suggested keywords 112. These other measurements may include query frequencies of the keywords in the intermediate set of keywords, relevancy scores of the keywords in the intermediate set of keywords with respect to the advertising target, and cross-similarities of the keywords in the intermediate set of keywords with respect to each other. The query frequencies may be retrieved from search logs, auction logs, or advertiser databases. The relevancy scores may be those calculated by the relevancy filtering module 106 and may be received by the bidding keyword selection module 108 from the relevancy filtering module 106. And as mentioned above, the cross-similarities may have been pre-computed for each keyword in the keyword superset 104 with respect to each other keyword in the keyword superset 104. In other embodiments, the bidding keyword selection module 108 determines the cross-similarities of the keywords in the intermediate set of keywords with respect to each other in the same manner that the relevancy filtering module 106 determined similarity measurements. The bidding keyword selection module 108 may use query frequencies to account for popularity and cross-similarities to allow relative concentration on a semantic topic.

In various embodiments, the bidding keyword selection module 108 utilizes a combinatorial optimization algorithm to select the subset of suggested keywords 112. The combinatorial optimization algorithm outputs a result vector N, that vector specified as N={n₁, n₂, . . . , nₘ}, with n₁, n₂, . . . , nₘ being the words in the intermediate set of keywords and m being the number of words in the intermediate set of keywords. Each nᵢ in N corresponds to a keyword in the intermediate set of keywords sharing the same index i and is assigned a value of 0 if that keyword is not selected to be in the subset of suggested keywords 112 and is assigned a value of 1 if the keyword is selected to be in the subset of suggested keywords. In some embodiments, the bidding keyword selection module 108 relaxes the values of N to be real values in the interval between 0 and 1 and converting the combinatorial optimization algorithm to a quadratic optimization problem.

In some embodiments, the combinatorial optimization algorithm includes terms for the measures of competition, the keyword prices, the query frequencies, the relevancy scores, the cross-similarities, and the budget constraint. Such a combinatorial optimization algorithm may be defined as:

$${max}_{{n}_{i} , i = 1 , 2 , … , m} \{ \frac{1}{2} α {\sum }_{i} {\sum }_{j} {s}_{ij} {n}_{i} {n}_{j} + β {\sum }_{i} {f}_{i} {n}_{i} + γ {\sum }_{i} {r}_{i} {n}_{i} - δ {\sum }_{i} {c}_{i} {n}_{i} \}$$

$$s . t . {\sum }_{i} ρ {p}_{i} {f}_{i} {n}_{i} \leq b$$

where nᵢ is a result for an i^{th} keyword, nⱼ is a result for all j^{th} keyword, m is the number of the plurality of keywords, sᵢⱼ is a measure of similarity between the i^{th} and j^{th} keywords, fᵢ is a query frequency of the i^{th} keyword, rᵢ is a relevancy score of the i^{th} keyword, cᵢ is a measure of competition for the i^{th} keyword, pᵢ is a keyword price for the i^{th} is the budget constraint, and α, β, γ, δ, and ρ are weighting factors. The weighting factors may be tuned heuristically or based on experience in order to maximize advertiser profits. The combinatorial optimization algorithm minimizes the term representing the measures of competition and maximizes the terms representing the keyword prices, the query frequencies, the relevancy scores, and the cross-similarities of the selected keywords with respect to each other. Also, as can be seen in the above definition, the combinatorial optimization algorithm uses the budget constraint as an upper bound to a sum of products of the keyword prices of the selected keywords with click-through rates of the selected keywords and query frequencies of the selected keywords.

In some embodiments, the bidding keyword selection module 108 then uses the result vector N to filter the intermediate set of keywords and select the subset of suggested keywords 112. For example, the bidding keyword selection module 108 may filter out any iₜₕ associated with a result value nᵢ of 0 or retain only i^{th} keywords associated with result values value nᵢ of 1. In embodiments in which the values of N are relaxed to be within the interval between 0 and 1, the bidding keyword selection module 108 may select a specified number of keywords associated which the greatest magnitude result values (i.e., values at or closest to 1) or may select keywords associated with result values exceeding a threshold.

In various embodiments, the bidding keyword selection module 108 then outputs the selected subset of suggested keywords 112. In embodiments in which the bidding keyword selection module 108 determined keyword prices, the bidding keyword selection module 108 may also output the keyword prices associated with the subset of suggested keywords 112. The computing device 102 may then store the subset of suggested keywords 112 and keyword prices locally and/or remotely and may provide the subset of suggested keywords 112 and keyword prices to the advertiser associated with the advertising target to facilitate the advertiser in bidding on the keywords in the subset of suggested keywords 112.

### Example System Architecture

FIG. 2 is a block diagram of an example computing device system architecture of a computing device configured to select a keyword subset based on measures of competition, in accordance with various embodiments. As shown, the computing device 102 may comprise at least a memory 202 (including a cache memory) and one or more processing units (or processor(s)) 204. Processor(s) 204 may be any known processors and/or may include one or more graphic processing units (GPUs).

Memory 202 may store program instructions that are loadable and executable on the processor(s) 204, as well as data generated during the execution of these programs. Depending on the configuration and type of computing device, memory 202 may be volatile (such as random access memory (RAM)) and/or non-volatile (such as read-only memory (ROM), flash memory, etc.). The computing device or server may also include additional removable storage 206 and/or non-removable storage 208 including, but not limited to, magnetic storage, optical disks, and/or tape storage. The disk drives and their associated computer-readable media may provide non-volatile storage of computer readable instructions, data structures, program modules, and other data for the computing devices. In some implementations, the memory 202 may include multiple different types of memory, such as static random access memory (SRAM), dynamic random access memory (DRAM), or ROM.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, erasable programmable read-only memory (EEPROM), flash memory or other memory technology, compact disc read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

The computing device 102 may also contain communications connection(s) 210 that allow the computing device 102 to communicate with a stored database, another computing device or server, user terminals, and/or other devices on a network. The computing device 102 may also include input device(s) 212, such as a keyboard, mouse, pen, voice input device, touch input device, etc., and output device(s) 214, such as a display, speakers, printer, etc.

Turning to the contents of the memory 202 in more detail, the memory 202 may include a platform 216. The platform 216 may comprise an operating system and/or one or more application programs or services. The memory 202 may also include the relevancy filtering module 108 and the bidding keyword selection module 110, which may each represent any one or more modules, applications, processes, threads, or functions. The relevancy filtering module 108 and the bidding keyword selection module 110 are described above in greater detail. The memory 202 may further store data associated with and used by the relevancy filtering module 108 and the bidding keyword selection module 110, as well as modules for performing other operations.

### Example Operations

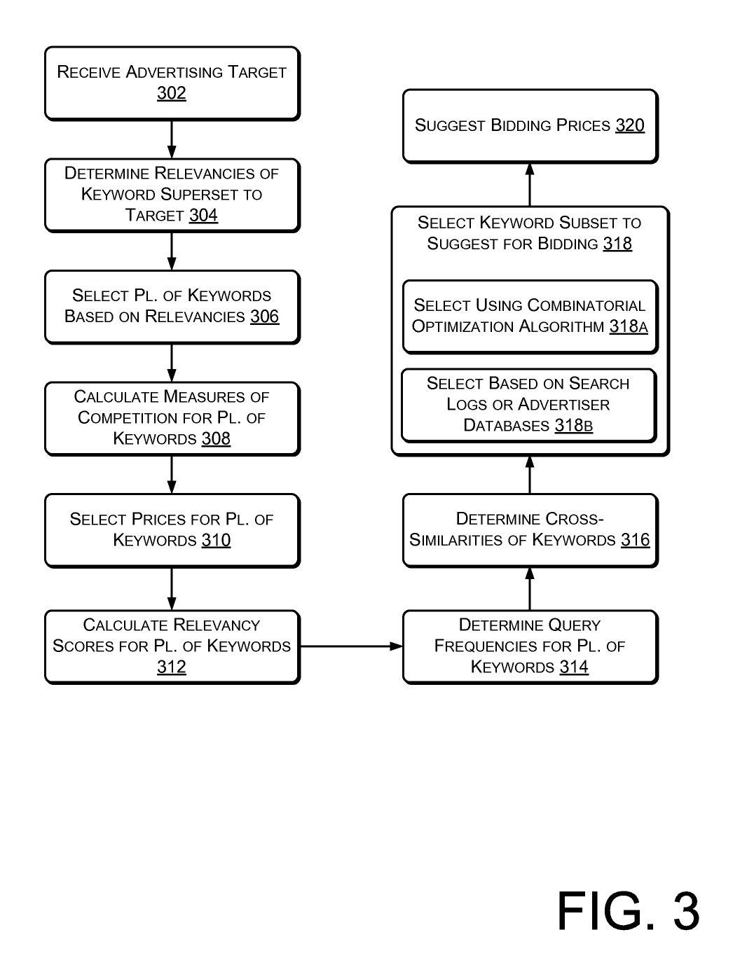

FIG. 3 is a flowchart showing an illustrative process for selecting a keyword subset based on measures of competition, in accordance with various embodiments. The operations of the processes are illustrated in individual blocks and summarized with reference to those blocks. These processes are illustrated as logical flow graphs, each operation of which may represent a set of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

As illustrated at block 302, a computing device receives at least one advertising target from an advertiser. The advertising target comprises at least one of one or more advertisement copies or one or more previously bid keywords, the advertisement copies and previously bid keywords being associated with an advertisement group of the advertiser.

At block 304, the computing device determines relevancies of a superset of keywords to the at least one advertising target and, at block 306, selects a plurality of keywords from the superset of keywords based on the determined relevancies.

At block 308, the computing device calculates measures of competition associated with the keywords of the plurality of keywords. Each measure of competition for a respective keyword is calculated based on a number of bidders for the respective keyword and on a number of available advertisement slots in search results provided responsive to queries for the respective keyword.

At block 310, the computing device selects as the keyword price for each keyword a lowest price for the keyword over a time period.

At block 312, the computing device calculates a relevancy score of each keyword of the plurality of keywords as an average of similarities of the keyword to a set of words representing the advertising target.

At block 314, the computing device determines a query frequency associated with each keyword as the frequency with which the keyword is queried during a time period.

At block 316, the computing device determines cross-similarities of the selected keywords with respect to each other.

At block 318, the computing device selects a subset of the keywords to suggest for bidding. The computing device selects the subset of keywords based at least on the measures of competition. At block 318a, the computing device selects the subset of the keywords based on a result of a combinatorial optimization algorithm that includes terms representing one or more of: the measures of competition, the keyword prices, the query frequencies associated with the keywords, the relevancy scores of the keywords with respect to the advertising target, the cross-similarities of the selected keywords with respect to each other, or a budget constraint. In some embodiments, the combinatorial optimization algorithm minimizes the term representing the measures of competition and maximizes the terms representing the keyword prices, the query frequencies, the relevancy scores, and the cross-similarities of the selected keywords with respect to each other. Also, the combinatorial optimization algorithm may use the budget constraint as an upper bound to a sum of products of the keyword prices of the selected keywords with click-through rates of the selected keywords and query frequencies of the selected keywords. Further, one or more of the terms of the combinatorial optimization algorithm may be associated with weighting factors. At block 318b, the computing device selects the subset of the keywords based on relevancy scores and query frequencies determined with reference to a search log or an advertiser database.

At block 320, the computing device suggests a bidding price for one or more keywords of the subset of keywords. The suggested bidding price may be the keyword price selected at block 310.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

We claim:

1. A method comprising:
receiving, by one or more computing devices, a plurality of keywords relevant to at least one advertising target;
calculating, by the one or more computing devices, measures of competition associated with the keywords, each measure of competition for a respective keyword being calculated based on a number of bidders for the respective keyword and on a number of available advertisement slots in search results provided responsive to queries for the respective keyword; and
selecting, based at least on the measures of competition, by the one or more computing devices, a subset of the keywords to suggest for bidding.

2. The method of claim 1, further comprising:
determining relevancies of a superset of keywords to the at least one advertising target; and
selecting the plurality of keywords from the superset of keywords based on the determined relevancies.

3. The method of claim 1, wherein the at least one advertising target comprises at least one of one or more advertisement copies or one or more previously bid keywords, the advertisement copies and previously bid keywords associated with an advertisement group.

4. The method of claim 1, wherein the selecting comprises selecting the subset of the keywords based on a result of a combinatorial optimization algorithm that includes terms representing one or more of:
the measures of competition,
keyword prices,
query frequencies associated with the keywords,
relevancy scores of the keywords with respect to the advertising target,
cross-similarities of the selected keywords with respect to each other, or
a budget constraint.

5. The method of claim 4, further comprising selecting as the keyword price for each keyword a lowest price for the keyword over a time period.

6. The method of claim 4, wherein the advertising target comprises a set of words and the relevancy score of each keyword is calculated as an average of similarities of the keyword to the set of words.

7. The method of claim 4, wherein the query frequency associated with each keyword is a frequency with which the keyword is queried during a time period.

8. The method of claim 4, wherein the combinatorial optimization algorithm minimizes the term representing the measures of competition and maximizes the terms representing the keyword prices, the query frequencies, the relevancy scores, and the cross-similarities of the selected keywords with respect to each other.

9. The method of claim 4, wherein the combinatorial optimization algorithm uses the budget constraint as an upper bound to a sum of products of the keyword prices of the selected keywords with click-through rates of the selected keywords and query frequencies of the selected keywords.

10. The method of claim 4, wherein one or more of the terms of the combinatorial optimization algorithm are associated with weighting factors.

11. The method of claim 4, wherein the combinatorial optimization algorithm is defined as:
$${max}_{{n}_{i} , i = 1 , 2 , … , m} \{ \frac{1}{2} α {\sum }_{i} {\sum }_{j} {s}_{ij} {n}_{i} {n}_{j} + β {\sum }_{i} {f}_{i} {n}_{i} + γ {\sum }_{i} {r}_{i} {n}_{i} - δ {\sum }_{i} {c}_{i} {n}_{i} \}$$
$$s . t . {\sum }_{i} ρ {p}_{i} {f}_{i} {n}_{i} \leq b$$
wherein nᵢ is a result for an i^{th} keyword, nⱼ is a result for an j^{th} keyword, m is the number of the plurality of keywords, sᵢⱼ is a measure of similarity between the i^{th} and j^{th} keywords, fᵢ is a query frequency of the i^{th} keyword, rᵢ is a relevancy score of the i^{th} keyword, cᵢ is a measure of competition for the i^{th} keyword, pᵢ is a keyword price for the i^{th} keyword, b is the budget constraint, and α, β, γ, δ, and ρ are weighting factors.

12. The method of claim 1, further comprising suggesting a bidding price for one or more keywords of the subset of keywords.

13. The method of claim 1, wherein the selecting further comprises selecting the subset of the keywords based on relevancy scores and query frequencies determined with reference to a search log or an advertiser database.

14. One or more computer storage media storing a plurality of computer-executable instructions configured to program one or more computing devices to perform operations comprising:
receiving a plurality of keywords relevant to at least one advertising target;
calculating measures of competition associated with the keywords, each measure of competition for a respective keyword being calculated based on a number of bidders for the respective keyword and on a number of available advertisement slots in search results provided responsive to queries for the respective keyword; and
selecting a subset of the keywords to suggest for bidding, the selecting based at least on the measures of competition and on one or more of query frequencies associated with the keywords, keyword prices, relevancy scores of the keywords, or cross-similarities of the keywords with respect to each other.

15. The one or more computer storage devices of claim 14, wherein the operations further comprise determining relevancies of a superset of keywords to the at least one advertising target and selecting the plurality of keywords from the superset of keywords based on the determined relevancies.

16. The one or more computer storage devices of claim 14, wherein the at least one advertising target comprises at least one of one or more advertisement copies or one or more previously bid keywords, the advertisement copies and previously bid keywords associated with an advertisement group.

17. The one or more computer storage devices of claim 14, wherein the selecting comprises selecting the subset of the keywords based on a result of a combinatorial optimization algorithm that includes terms representing one or more of the measures of competition, the keyword prices, the query frequencies, the relevancy scores of the keywords with respect to the advertising target, the cross-similarities of the selected keywords with respect to each other, or a budget constraint.

18. The one or more computer storage devices of claim 14, wherein the relevancy scores and query frequencies are determined with reference to a search log or an advertiser database.

19. A system comprising:
one or more processors;
a filtering module configured to be operated by the one or more processors to determine relevancies of a superset of keywords to at least one advertising target and select a plurality of keywords from the superset of keywords based on the determined relevancies; and
a bidding keyword selection module configured to be operated by the one or more processors to:
calculate measures of competition associated with the keywords of the plurality of keywords, each measure of competition for a respective keyword being calculated based on a number of bidders for the respective keyword and on a number of available advertisement slots in search results provided responsive to queries for the respective keyword; and
select a subset of keywords to suggest for bidding from the plurality of keywords, the selecting based at least on the measures of competition and on one or more of query frequencies associated with the keywords, keyword prices, relevancy scores of the keywords, or cross-similarities of the selected keywords with respect to each other.

20. The system of claim 19, wherein the bidding keyword selection module comprises a combinatorial optimization algorithm that includes terms representing one or more of: the measures of competition, the keyword prices, the query frequencies, the relevancy scores of the keywords with respect to the advertising target, the cross-similarities of the selected keywords with respect to each other, or a budget constraint.
